(19) United States
(12) Patent Application Publication
(10) Pub. No.: US 2013/0317943 A1
(43) Pub. Date: Nov. 28, 2013

(54) TRADE SHOW AND EXHIBITION APPLICATION FOR COLLECTABLES AND ITS METHOD OF USE

(71) Applicant: CASSI EAST, ORANGE, CA (US)

(72) Inventor: CASSI EAST, ORANGE, CA (US)

(21) Appl. No.: 13/891,470

(22) Filed: May 10, 2013

Related U.S. Application Data
(60) Provisional application No. 61/645,826, filed on May 11, 2012.

(51) Int. Cl. G06Q 30/06

(52) U.S. Cl. CPC G06Q 30/0623
USPC 705/26.61

(57) ABSTRACT

A trade show and exhibition interaction application tool is described that includes an archived collection, a database or a combination thereof of collectable items, a communication component, and an interaction component, wherein the trade show and exhibition interaction application tool is stored on and executed from a hand held device, tablet computer, laptop computer, desktop computer or a combination thereof. A method of using a trade show and exhibition interaction application tool is also disclosed.

This United States Utility Application claims priority to U.S. Provisional Application Ser. No. 61/645,826 filed on May 11, 2012 and entitled “Trade Show and Exhibition Software Application for Collectables and Its Method of Use”, which is commonly owned and is incorporated herein in its entirety by reference.

### FIELD OF THE SUBJECT MATTER

The field of the subject matter is trade show and exhibition applications targeted to collectables and their methods of use.

### BACKGROUND

Trade shows and exhibitions are generally highly attended events with several different vendors in large spaces, such as a convention center floor or large hotel space. At many of these events, attendees can be seen walking up and down each aisle, looking at products and services, without any end goal. These events now distribute maps of the vendors on the floor, along with a general description of the vendor (maybe 50 words), but if the attendee is looking for a specific item, hours of time can be spent trying to locate a vendor with that item and then speak with the vendor about cost and availability.

US Patent Publication 2010/0023404 discloses a system that is used to help display and manage showroom items. The problem to be solved, in this case, is that the preparation of pre-printed paper line sheets and order forms, along with providing handheld fabric swatch cards, takes time and is expensive. In this application, a vendor can update the system software with the specific showroom items, wherein the software will display a “digital line sheet” showing the available inventory to a buyer and where the pieces of the inventory can be found. The buyer can then use the software to record and store notes about one or more of the showroom items. The buyer can then use the digital line sheet or a remote on-site computer to prepare and complete an order for one or more of the showroom items. In these embodiments, however, the buyer is looking at list of available items provided by the vendor and making selections based on that digital line sheet.

U.S. Pat. No. 6,595,417 entitled “Electronic Shopping System” discloses an information system that can be used by customers in a retail shopping environment where a host computer stores and accesses product information when prompted by a customer who is using a portable terminal. This shopping system is a closed system in that it is designed to be used only within the retail space and only on a targeted terminal. Once the customer leaves the space, the terminal must be turned in and the customer cannot use that information again to, for example, comparison shop, store a wish list that can be updated and/or pinged when something new comes into the inventory or the price changes and other desirable actions.

U.S. Pat. No. 6,604,681 entitled “Evaluative Shopping Assistant System” discloses a method for aiding a shopper by providing a portable device and a communications system with respect to what is in the physical location. Like the last patent, this shopping system is a closed system in that it is designed to be used only within the retail space and only on a targeted terminal. Once the customer leaves the space, the terminal must be turned in and the customer cannot use that information again to, for example, comparison shop, store a wish list that can be updated and/or pinged when something new comes into the inventory or the price changes and other desirable actions.

U.S. Pat. No. 6,640,232 entitled “Apparatus and Method for Accessing a Coin Image Compilation” discloses a method of trading a graded object electronically by storing images, making them available to a buyer at a remote terminal who can then purchase the object. Again, this is very limited in that the buyer is at the whim of the vendor database and the vendor itself. The buyer isn'table to comparison shop easily using a database that is updated on the fly and in real time. The buyer also isn'table to set up a wish list and watch list that will interact with various databases to return available commodities as they become available.

There is still a need, especially in the collectables field, to be able to provide a show or exhibition attendee with a real-time and robust search application that allows the attendee to search for those items that are specifically desired and that are on the floor or available from those specific vendors. Contemplated embodiments that are disclosed herein are designed to meet this need in the industry.

### SUMMARY OF THE SUBJECT MATTER

A trade show and exhibition interaction application tool is described that includes an archived collection, a database or a combination thereof of collectable items, a communication component, and an interaction component, wherein the trade show and exhibition interaction application tool is stored on and executed from a hand held device, tablet computer, laptop computer, desktop computer or a combination thereof.

A method of using a trade show and exhibition interaction application tool includes: providing an archived collection, a database or a combination thereof of collectable items, providing a communication component, providing an interaction component, wherein the trade show and exhibition interaction application tool is stored on and executed from a hand held device, tablet computer, laptop computer, desktop computer or a combination thereof, operatively utilizing the hand held device, tablet computer, laptop computer, desktop computer or a combination thereof to connect to the communication component, and executing the trade show and exhibition interaction application tool on the hand held device, tablet computer, laptop computer, desktop computer or a combination thereof, wherein the tool operatively engages the interaction component, the archived collection, a database or a combination thereof of collectable items or a combination thereof.

### BRIEF DESCRIPTION OF THE FIGURES

FIG. 1 shows a schematic of a contemplated trade show and exhibition interaction application tool.

FIG. 2 shows a method of using a contemplated trade show and exhibition interaction application tool.

FIG. 3 shows a schematic of a contemplated trade show and exhibition interaction application tool.

### DETAILED DESCRIPTION

A contemplated software application comprises the following: a) an interactive and fluid database that allows for on-the-fly cataloging and updating of collectable items by at least one vendor, b) a wireless support network, c) a two-way communication link that is supported by the wireless support network, d) a vendor-side interface, and e) an attendee-side interface. A complementary system of local, wired computers may also be included in some contemplated embodiments. In some embodiments, advertising and other information can be included on the vendor-side interface, the attendee-side interface or a combination thereof.

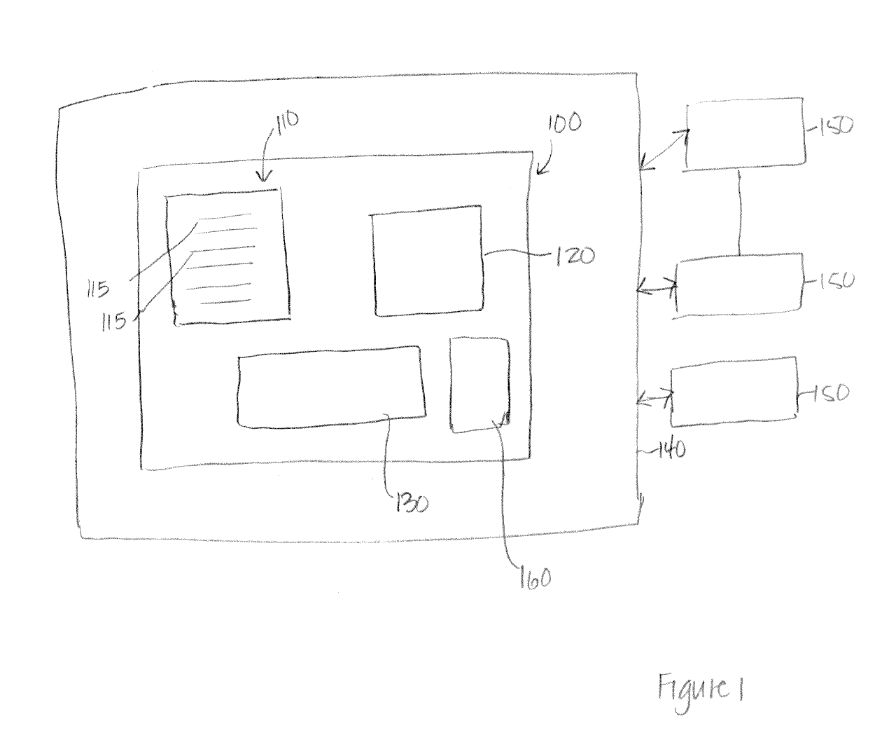

Specifically and as shown in FIG. 1, a trade show and exhibition interaction application tool 100 is described that includes an archived collection, a database or a combination thereof 110 of collectable items 115, a communication component 120, and an interaction component 130, wherein the trade show and exhibition interaction application tool is stored on and executed from a hand held device, tablet computer, laptop computer, desktop computer or a combination thereof 140. Contemplated interaction application tools can further comprise a complementary system of local, wired or wireless computers 150. In addition, some contemplated interaction application tools can further comprise advertising 160 and other related information, such as webpage addresses, E-mail addresses, phone numbers, social media identifiers and related information.

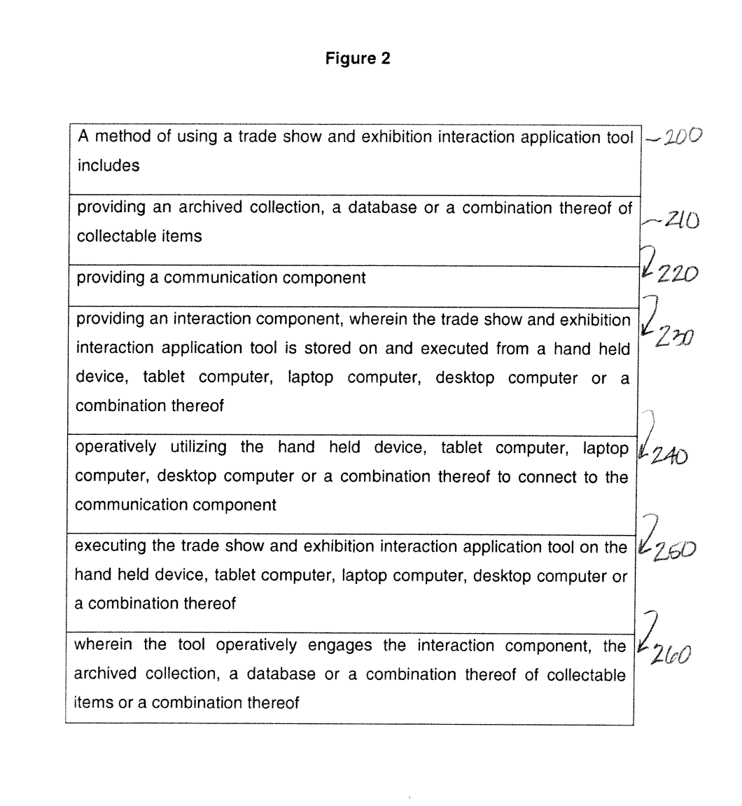

A method 200, as shown in FIG. 2, of using a trade show and exhibition interaction application tool includes: providing 210 an archived collection, a database or a combination thereof of collectable items, providing 220 a communication component, providing 230 an interaction component, wherein the trade show and exhibition interaction application tool is stored on and executed from a hand held device, tablet computer, laptop computer, desktop computer or a combination thereof, operatively utilizing 240 the hand held device, tablet computer, laptop computer, desktop computer or a combination thereof to connect to the communication component, and executing 250 the trade show and exhibition interaction application tool on the hand held device, tablet computer, laptop computer, desktop computer or a combination thereof, wherein the tool operatively engages 260 the interaction component, the archived collection, a database or a combination thereof of collectable items or a combination thereof.

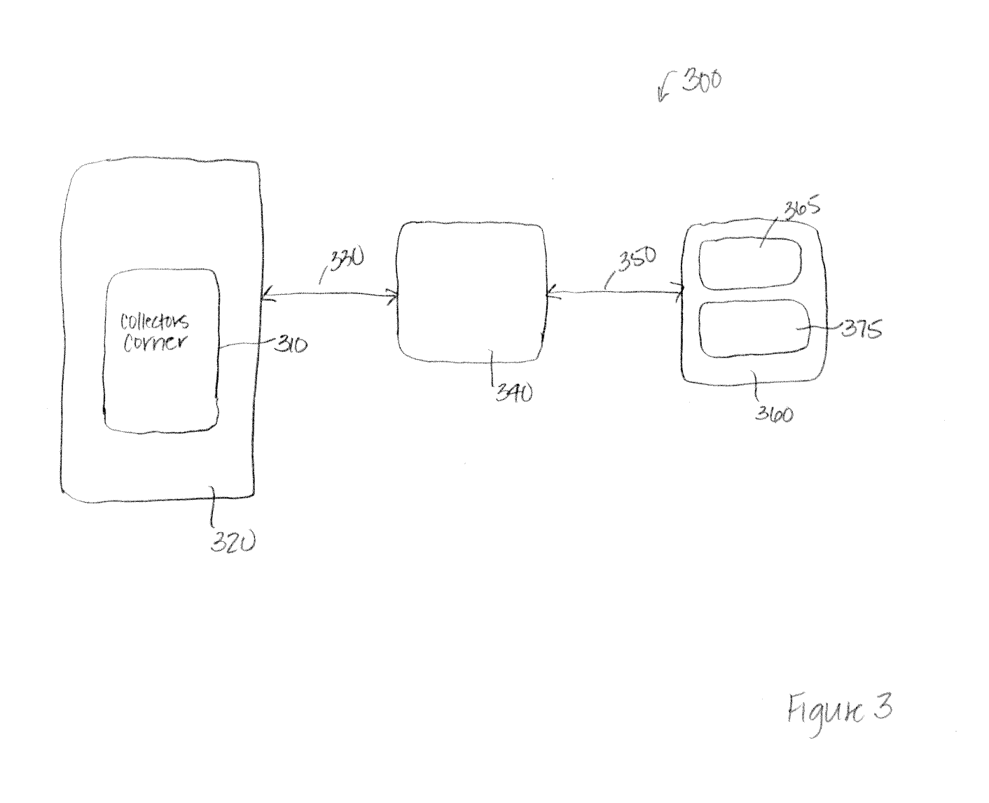

FIG. 3 shows a schematic of how a contemplated method and related tool 300 would operate. A contemplated interaction application tool 310 is viewably located on a hand held device 320, tablet, laptop computer, desktop computer or combination thereof. Once the user (not shown) engages the interaction application tool 310, it operatively engages 330 the communication component 340, which can include a wireless communications network, in order to operatively engage 350 the interaction component 360. As mentioned, the interaction component 360 comprises and can operatively access the vendor-side interface 365, the attendee-side interface 375 or the combination thereof to allow the user to access one or both on the hand held device 320 over the wireless network.

In some contemplated embodiments, the collectable item comprises a coin, a paper currency, a trading card, a stamp, a motorized vehicle or a combination thereof. In a specific embodiment, the trading card comprises a sports trading card, such as a baseball trading card, a football trading card, a hockey trading card, a basketball trading card or another suitable sports trading card.

Contemplated collectable items can be cataloged or otherwise linked together by utilizing an archived collection, a database or a combination thereof. Contemplated archived collections, databases or other suitable electronic/digital cataloging system allows the user to access the collectable title, photo or image, brief and/or detailed description, estimated or confirmed value, recent sales price, number available, quality, and any other desirable or necessary commodities or collectables information for both the vendor and consumer. Contemplated archived collections, databases or other suitable electronic/digital cataloging system are stored on any suitable electronic or digital storage medium or media.

Vendors or exhibitors who are bringing, showing and hopefully, selling collectable items at an event would provide or upload a list of the collectable items to or into the interactive event database, along with any relevant information regarding quality of each item, value, price, images of the collectable and/or other information that collectors may find necessary or desirable depending on the collectable item. In addition, contemplated relevant information can include the image of the actual item that is on the show or exhibition floor—the image of the exact item for sale and not just a representation of the item or a generic image. These participating vendors and/or exhibitors would also pay a fee to participate in the database.

The interactive database may be connected to the event payment system or may be updated on-the-fly by each vendor. For example, some events provide vendors with cash registers and computers that track sales, and in these cases, the interactive database may be automatically updated to remove an item, as each sale is posted. Other events and shows rely on the vendor to provide his/her own payment system and computer, and in these embodiments, the vendor will need to update their portion of the database using the vendor-side interface.

Contemplated archived collections, interactive databases or combinations thereof are operatively coupled or connected to or with the interaction component. Contemplated interaction components comprise a vendor-side interface, an attendee-side interface or a combination thereof, as disclosed and described herein. Contemplated interaction components are operatively coupled with or connected to the communication component.

Contemplated interactive databases may be stored locally onsite at the event, may be stored on a network or may be stored on an external sharing space, such as the Cloud™. Contemplated interactive databases may be made available to the general public who cannot attend the event. In some embodiments, it may be that the event organizers charge a fee to members of the general public to give them the opportunity to search the database and buy collectables remotely.

Contemplated embodiments comprise a communication component, and in some embodiments, comprise at least two communication components. A contemplated wireless support network and two-way communication link is designed ultimately to put the event attendee in touch with a targeted and correct vendor. Any suitable device that allows this communication between an attendee and a vendor through the interactive database is contemplated. Suitable devices may include a hand held device, a cell phone, a tablet or iPad™, a blackberry or other type of smart phone device, a laptop computer, a desktop computer, a show specific device or a combination thereof.

Contemplated vendor-side interfaces may be any suitable software application that allows the vendor to archive/inventory and upload information into the interactive database. These vendor-side interfaces may be show specific, in that the vendor manually provides information to the event's interactive database before the show by using the event software or through the event site. Contemplated vendor-side interfaces may also be such that the software is always used by the vendor to track inventory and when the vendor attends the show, he or she selects the collectable pieces that will be available at that event and submits them electronically and through the software to the event database.

From the attendee side—or attendee-side interfaces, a contemplated software application is designed to be readily accessible, searchable and updatable, so that the attendee can walk into the event and find the specific collectable that he or she is looking for in the condition that he and she desires and for a price that is acceptable to the attendee.

In addition and in some embodiments, an attendee can select one of the items returned by the search and be linked to a database containing detailed information about that item, such as a price guide, population report, auction prices realized, survival rates and additional information that is standard for the collectables field. Attendees and buyers can create a “Collectors Corner” account as part of their application that will tag items for referencing later, store purchased or sold items, store desirable items that buyer would like to find and/or purchase and other information, such as collectors notes.

This software and process differs from the earlier cited art in that the attendee isn't presented with a “show list” of everything, but instead is presented with a search interface where terms can be either entered or selected to find that desired collectable. The attendee-side interface will also include a “shopping cart” or “cart” where potential purchases can be stored until the in-person or virtual attendee checks out and pays for the items.

### EXAMPLES

### Example 1

### Coin Show

An attendee at a coin show comes to the show for a number of reasons, but wants to find an 1863 Republic Shipwreck gold coin that has been authenticated and is in good to very good condition. The attendee clicks on the “Collectors Corner” on his iPad™ and pulls up the search grid. The attendee can type in “Republic” and “Shipwreck”, along with clicking a box for “good condition” and another box for “very good condition”. The software application returns the following information for the attendee:

| | | | Vendor | |
|---|---|---|---|---|
| Coin | Condition | Vendor | Location | Cost |
| 1863 Republic | Good | International | E-1844 | $40 |
| Shipwreck | | Coins & | | |
| | | Stamps | | |
| 1863 Republic | Good | SuperCoin | D-2464 | $40 |
| Shipwreck | | | | |
| 1863 Republic | Very Good | International | E-1844 | $50 |
| Shipwreck | | Coins & | | |
| | | Stamps | | |
| 1863 Republic | Very Good | Bob's | A-204 | $52 |
| Shipwreck | | Collectables | | |

The attendee is free to visit any or all of these vendors to review this coin. If Bob's Collectables sells the coin in the interim, it will be removed from the available interactive database.

### Example 2

### Sports Collectables Show—Onsite and Online Availability

A Sports Collectables Show in Lawrence, Kans. offers “virtual attendees” the ability to access the show collectables online by paying a $25 entrance fee. An online attendee in San Diego, Calif. is looking for two things: a) an Albert Pujols Topps rookie card in mint or excellent condition, and b) a game-used baseball signed by Greg Maddox, Tom Glavine and John Smoltz. The attendee clicks on the “Collectors Corner” on his laptop computer or desktop computer and the software application requests that he enter the “Show Code” provided to him when he registered to be a virtual attendee. Once the code is entered, the software application pulls up the search grid. The attendee can type parameters for both the Pujols rookie card and the signed baseball together, in order to find out if one vendor has both, which may be desirable for negotiation purposes. The software application returns the following information for the attendee:

| | | | Vendor | |
|---|---|---|---|---|
| Collectable | Condition | Vendor | Location | Cost |
| Albert Pujols | Mint | Topps Cards | E-1844 | $100 |
| Topps Rookie | | | | |
| Card | | | | |
| Albert Pujols | Mint | Bob's | D-2464 | $102 |
| Topps Rookie | | Collectables | | |
| Card | | | | |
| Albert Pujols | Excellent | The Sports | A-204 | $75 |
| Topps Rookie | | Page | | |
| Card | | | | |
| Signed | Game-Used | Bob's | D-2464 | $250 |
| Baseball: | | Collectables | | |
| Maddox, | | | | |
| Glavine, Smoltz | | | | |

The “Vendor Location” column is hyperlinked, so that when the user clicks on the link, the user can communicate with the vendor onsite whether it is by Email, phone, visually, or another electronic communication. The user can then negotiate the final price for one or both items with the vendor directly.

Thus, specific embodiments of trade show and exhibition applications targeted to collectables and their methods of use have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A trade show and exhibition interaction application tool, comprising:
an archived collection, a database or a combination thereof of collectable items,
a communication component, and
an interaction component, wherein the trade show and exhibition interaction application tool is stored on and executed from a hand held device, tablet computer, laptop computer, desktop computer or a combination thereof.

2. The trade show and exhibition interaction application tool of claim 1, wherein the tool is stored on a computer network server, internet server, cloud or combination thereof.

3. The trade show and exhibition interaction application tool of claim 1, wherein the communication component comprises at least two communication components.

4. The trade show and exhibition interaction application tool of claim 1, wherein the communication component comprises a hand held device, tablet computer, laptop computer, desktop computer or a combination thereof.

5. The trade show and exhibition interaction application tool of claim 1, wherein the archived collection, the database or the combination thereof is operatively coupled with the interaction component.

6. The trade show and exhibition interaction application tool of claim 1, wherein the interaction component is operatively coupled with the communication component.

7. The trade show and exhibition interaction application tool of claim 1, wherein the archived collection, the database or the combination thereof is updateable in real-time.

8. The trade show and exhibition interaction application tool of claim 1, wherein the archived collection, the database or the combination thereof is updateable in real-time by a vendor, a seller, a buyer or a combination thereof.

9. The trade show and exhibition interaction application tool of claim 1, wherein the communication component comprises a wireless support network.

10. The trade show and exhibition interaction application tool of claim 1, wherein the communication component comprises a two-way communication link that is supported by the wireless support network.

11. The trade show and exhibition interaction application tool of claim 1, wherein the interaction component comprises a vendor-side interface, an attendee-side interface or a combination thereof.

12. The trade show and exhibition interaction application tool of claim 1, wherein the tool further comprises a complementary system of local, wired computers.

13. The trade show and exhibition interaction application tool of claim 1, wherein the tool further comprises advertising and other information.

14. A method of using a trade show and exhibition interaction application tool, comprising:
providing an archived collection, a database or a combination thereof of collectable items,
providing a communication component,
providing an interaction component, wherein the trade show and exhibition interaction application tool is stored on and executed from a hand held device, tablet computer, laptop computer, desktop computer or a combination thereof,
operatively utilizing the hand held device, tablet computer, laptop computer, desktop computer or a combination thereof to connect to the communication component, and
executing the trade show and exhibition interaction application tool on the hand held device, tablet computer, laptop computer, desktop computer or a combination thereof, wherein the tool operatively engages the interaction component, the archived collection, a database or a combination thereof of collectable items or a combination thereof.
